(19) United States
(12) Patent Application Publication
(10) Pub. No.: US 2010/0240414 A1
(43) Pub. Date: Sep. 23, 2010

(54) METHOD AND APPARATUS TO HAVE MORE SIM CARDS THAN CELLULAR MODEMS AND ASSIGN THE SIM CARDS TO THE MODEMS AT RUN TIME

(76) Inventor: Ran Lotenberg, Raanana (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/725,436

(22) Filed: Mar. 16, 2010

Related U.S. Application Data
(60) Provisional application No. 61/161,004, filed on Mar. 17, 2009.

(51) Int. Cl. H04M 1/00

(52) U.S. Cl. 455/558

(57) ABSTRACT

A hardware and software design that allows a device to have more SIM cards than modems and assign the SIM cards to these modems at run time. In addition the method can use information received from an external entity, like a server residing on the internet for example, with information about preferred network operator. Another exemplary decision making is based on trial: a device can test several SIM cards from different network operators, and select the set of SIM cards that exhibit best performance.

### CROSS-REFERENCE TO RELATED APPLICATIONS

This is a non-provisional application for a U.S. Patent being filed under 35 C.F.R. 1.53(b) and 35 U.S.C. 111 and claiming the benefit of priority to U.S. Provisional Application for Patent filed on Mar. 17, 2009 and assigned serial number 61/161,004, which application is incorporated herein by reference in its entirety.

### BACKGROUND

1. Field of Invention

The present invention relates to new way to use modem hardware and SIM cards to enable a device to attach to different operators and base stations.

2. Description of Background Art

In current cellular modem hardware design there is a one-to-one match between a SIM card and a radio hardware unit. These are viewed as one entity. This design is consistent both in handsets (cellular phones) and cellular modems.

In addition, in current 2G and 3G cellular networks, a cellular device connects to a base station according to predefined criteria. In 2G networks (e.g., GSM) a cellular device attaches to a base station with the best radio conditions. In 3G networks the attachment process is more complex and is negotiated with the network.

### SUMMARY OF THE DISCLOSURE

The disclosed embodiments provide a novel and new method of hardware and software design that allows a device to have more SIM cards than modems and assigns SIM cards to these modems at run time.

In addition the new method can use information received from an external entity, like a server residing on the internet for example, with information about preferred network operator. Another exemplary decision making is based on trial: a device can test several SIM cards from different network operators, and select the set of SIM cards that exhibit best performance.

We turn now to another innovation presented here which is the override of the default base station selection procedure. Here is a more detailed description:

A cellular device follows the standard communication protocols when attaching to a network. This implies attaching to a “default” base station. This default base station is determined by the device, the network, or a combination, as instructed by the standards.

A device with multiple SIM cards and modems can decide, however, to attach to other than the default base stations to achieve better performance. This device has more information than the cellular network, since it is “aware” to the fact that it uses several modems in parallel. For example, it can decide that attaching to a single base station is a single-point-of-failure.

Cellular standards (eg., GSM) mandates the way the handset/modem and network should behave. A device, handset or modem, attaches to a base station in a predefined procedure. However, in the new method, we change this procedure and introduce new information to the “decision making” by the device. Once, the device makes a selection of base station, it notifies the network and manipulates it, if necessary, to be able to attach to the selected base station.

In addition the new method can use information received from an external entity, like a server residing on the internet for example, with information about preferred base stations.

Other objectives, features, and advantages of the present invention will become apparent upon reading the following detailed description of the embodiments with the accompanying drawings and appended claims.

### BRIEF DESCRIPTION OF THE DRAWINGS

FIG. 1 illustrates an exemplary logical hardware design.

### DETAILED DESCRIPTION

The disclosed embodiments provide a novel and new method of hardware and software design that allows a device to have more SIM cards than modems and assigns SIM cards to these modems at run time.

In addition the new method can use information received from an external entity, like a server residing on the internet for example, with information about preferred network operator. Another exemplary decision making is based on trial: a device can test several SIM cards from different network operators, and select the set of SIM cards that exhibit best performance.

We turn now to another innovation presented here which is the override of the default base station selection procedure. Here is a more detailed description:

A cellular device follows the standard communication protocols when attaching to a network. This implies attaching to a “default” base station. This default base station is determined by the device, the network, or a combination, as instructed by the standards. Those skilled in the art will be aware of the various telecommunications and cellular telecommunications standards that define the general procedures and protocols for performing such action.

A device with multiple SIM cards and modems can decide, however, to attach to a different base station or mobile telephone switching system other than the default base stations to achieve better performance. For instance, as a non-limiting example, the device could connect cellular systems operated by different carriers. If, at the time the device seeks to make a connection, the device can look at the current signal strength of the cellular systems that are supported by the set of SIM cards and then, decide to use the SIM card for which the signal strength is strongest. Other criteria could include, or alternately be, congestion, current billing rates based on location, time of day, day of week, etc., interference, desired user preference, or even by identify the carrier that supports a called or received call number. This device has more information than the cellular network, since it is “aware” to the fact that it uses several modems in parallel. For example, it can decide that attaching to a single base station is a single-point-of-failure.

Cellular standards (eg., GSM) mandates the way the handset/modem and network should behave. A device, handset or modem, attaches to a base station in a predefined procedure. However, in the new method, we change this procedure and introduce new information to the “decision making” by the device. Once, the device makes a selection of base station, it notifies the network and manipulates it, if necessary, to be able to attach to the selected base station.

In addition the new method can use information received from an external entity, like a server residing on the internet for example, with information about preferred base stations.

Turning now to the figures in which like numerals represent like elements throughout the several views, exemplary embodiments of the present invention are described. For convenience, only some elements of the same group may be labeled with numerals. The purpose of the drawings is to describe exemplary embodiments and not for production. Therefore features shown in the figures are chosen for convenience and clarity of presentation only.

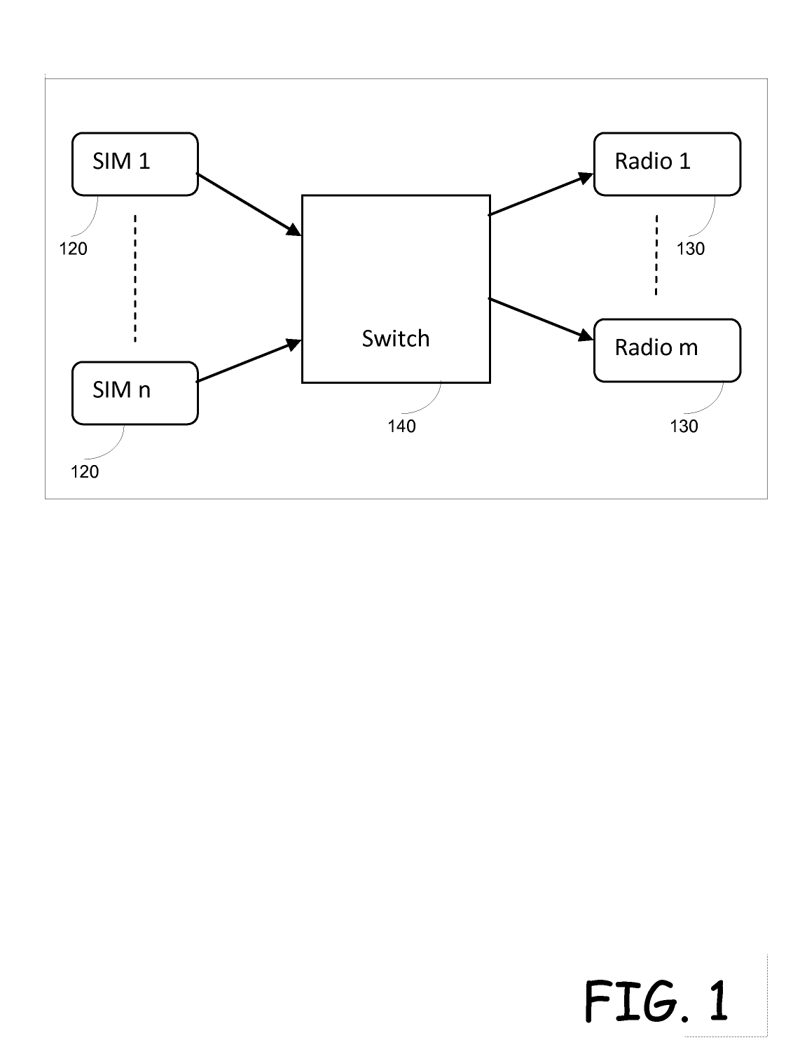

FIG. 1 is an exemplary hardware design diagram. It shows a high level logical hardware design of a system or board 100 with multiple SIM cards 120 and multiple cellular radio units 130. A switch 140 operates to assign the SIM cards to a radio unit.

Next we present real-world systems that are built according to the present disclosure. An apparatus is composed of a main board with CPU. Several slots for SIM cards and several cellular radio units. A switch allows the system to allocate each SIM card to every radio unit. Or, in some embodiments, as a radio attempts to connect, the switch can allocate one of the available SIM cards to the radio.

What is claimed is:

1. A method for operating a radio unit device that utilizes a plurality of SIM cards, the method comprising the steps of:
creating an assignment separation between the plurality of SIM cards and the radio unit;
assigning a SIM card selected from the plurality of SIM cards to a modem within the radio unit at run time.

2. An apparatus for operating a radio unit device that utilizes a plurality of SIM cards, the apparatus, comprising:
‘n’ SIM cards;
‘m’ modems associated with the radio unit, where m<n;
a control unit being configured to assign at least one of the n SIM cards to one of the m modems at run time.

3. A method to operate a radio device on a cellular network, the radio device having a plurality of SIM cards, the method comprising the steps of:
obtaining information about the cellular network;
analyzing the information about the cellular network to determine the current conditions for the radio device and the cellular network;
overriding the default behavior of the cellular network by controlling the selection of base stations for the radio device.

4. The method of claim 3, further comprising the step of obtaining information from an external entity and the step of analyzing the information further comprising analyzing the information from the external entity.
